(19) United States
(12) Patent Application Publication
(10) Pub. No.: US 2011/0305411 A1
(43) Pub. Date: Dec. 15, 2011

(54) Roller Bearing Cage

(75) Inventor: Ferdinand Schweitzer, St. Peter in der au (AT)

(73) Assignee: AKTIEBOLAGET SKF, Goteborg (SE)

(21) Appl. No.: 13/157,963

(22) Filed: Jun. 10, 2011

(30) Foreign Application Priority Data
Jun. 11, 2010 (DE) 10 2010 023 521.0

(51) Int. Cl. F16C 23/08; F16C 33/38

(52) U.S. Cl. 384/495; 384/523

(57) ABSTRACT

A roller bearing cage includes pockets for retaining roller bodies. Radially-extending bulges are disposed on bridges that at least partially define the pockets so as to extend radially inwardly and/or radially outwardly. The radially-extending bulges reduce edge stresses in the cage that develop when the roller bodies contact the cage during operation of the roller bearing.

### CROSS-REFERENCE

This application claims priority to German patent application no. 10 2010 023 521.0 filed on Jun. 11, 2010, the contents of which are incorporated by reference as if fully set forth herein.

### TECHNICAL FIELD

The present invention generally relates to a cage for a roller bearing, such as an angular contact ball bearing, that has pockets for retaining roller bodies of the roller bearing.

### BACKGROUND

It is known to insert cages into roller bearings, whereby the roller bodies are guided in the corresponding pockets of the cage during operation of the roller bearing. In fact, cages are utilized in a wide variety of types of roller bearings, such as cylindrical roller bearings, tapered roller bearings, ball bearings and angular contact ball bearings.

However, especially when the roller bearings are operated at high loads and/or high rotational speeds, cracks can develop on the cages. In the worst case, such cracks can lead to breakage of the cage.

### SUMMARY

In one aspect of the present teachings, an improved cage for a roller bearing is disclosed that has an increased service life as compared to known embodiments. Roller bearings, such as an angular contact ball bearing, which utilize the improved cage, are also disclosed.

The present teachings are based upon the recognition that cracks in the cages and, in some cases, breakages of the cages, occur because the roller bodies generate large stresses during contact with the edges of the cage pockets. On the one hand, this can occur in the loading zone even if the appropriate roller bodies are loaded in accordance with their bearing geometry and installation position. On the other hand, even un-loaded roller bodies can stress the edges of the cage pockets because they move in the cage pockets and thus can bump against the edges.

The cracks form predominantly around the edges of the pockets, where the roller body applies the greatest pressure during operation of the roller bearing. To avoid this cracking problem, it has been found to be expedient to reduce the edge stresses occurring at the edges of the cage pockets. This is applicable, in particular, to the areas around the edges, at which the greatest loading occurs due to the contact with the roller bodies, which substantially depends upon the geometry of the roller bearing.

In one exemplary embodiment of the present teachings, a cage for a roller bearing is thus provided with pockets for respectively retaining the roller bodies of the roller bearing. At least one outward shape (bulge) is provided at, near or around at least one of the pockets. The at least one outward shape is formed so as to extend from the cage radially inward or radially outward and is formed such that it reduces edge stresses that normally would occur in the cage when the roller bodies contact the cage. By reducing the edge stresses during operation, cracks can be more effectively prevented from forming in the cage. Thus, the occurrence of cage breakages is effectively suppressed or reduced. The means for reducing the edge stresses are preferably embodied as stress-reducing elements that are disposed on or in the cage. They are disposed on the cage such that they act at or along the portion(s) of the cage that is (are) subjected to the greatest load(s) during operation, e.g., at, near, around or along at least the portion of the edge of the pocket that serves as a guiding element for the respective roller bodies.

In another exemplary embodiment of the present teachings, a roller bearing cage includes pockets for retaining roller bodies. Radially-extending bulges are disposed on bridges that at least partially define the pockets so as to extend radially inwardly and/or radially outwardly. The radially-extending bulges reduce edge stresses in the cage that develop when the roller bodies contact the cage during operation of the roller bearing.

In a preferred embodiment, at least one outward shape is provided at, near, along or around each of the pockets. It is thereby effectively prevented that cracks can occur at or along any one of the pockets of the cage. The service life of such a cage is correspondingly increased as compared to known embodiments.

In another preferred embodiment, appropriate outward shapes are disposed on the radially-inner-lying opening of the pocket as well as on the radially-outer-lying opening of the pocket. During operation of the roller bearing, contact of the edge of the pocket with the roller body will occur, depending upon the type of the roller bearing, at the radially-outer-lying edge as well as at the radially-inner-lying edge. The radially-outer-lying opening is aligned substantially with the corresponding track or raceway surface for the roller body on the outer ring. In a corresponding manner, the radially-inner-lying opening is aligned substantially with the track or raceway surface on the inner ring. Depending upon the operational state of the roller bearing, the roller body will contact the edge of the radially-outer-lying opening or the edge of the radially-inner-lying opening. In this respect, it is advantageous to provide the corresponding edges of the pocket with outward shapes (bulges) to reduce the edge stress. This is, however, dependent upon the type of the roller bearing and the installation position so that, if necessary, appropriate outward shapes are provided only on the edge of one/each pocket.

In addition or in the alternative, appropriate outward shapes are disposed on both axial ends of the openings of the pockets. During operation of the roller bearing, it possible that the roller bodies will apply pressure to both axial ends of the opening of the pockets in different operational states. In this case, it is also advantageous to provide the corresponding edges of the pocket with means for reducing the edge stress. In combination with the arrangement of the means for reducing the stress, four outward shapes can thus, e.g., be disposed at each pocket of the cage.

In addition or in the alternative, the outward shapes may be located at the edge of the pocket. By placing the outward shapes at the edge of the respective pockets of the cage, a targeted reinforcement of the cage is achieved in each respective area of the disposed outward shapes. As a result, the cage is better able to withstand the pressure applied by the roller bodies during operation of the roller bearing.

In addition or in the alternative, outward shapes may be adapted or conformed to the shape of the bridges or spacers that extend between the pockets and serve as guiding elements for the roller bodies. In such an embodiment, the highly loaded area of the cage can be stabilized with an especially strong reinforcement in the best possible manner.

In another aspect of the present teachings, an angular contact ball bearing preferably includes a cage according to the present teachings. In particular in angular contact ball bearings, large loads occur due to the contact with the roller bearings during operation as a result of the mixed loading in the axial and radial directions. In this respect, the presently-disclosed cages can be utilized in angular contact ball bearings in a particular advantageous manner.

Further objects, embodiments, advantages and designs will be explained in the following with the assistance of the exemplary embodiments and the appended Figures.

### BRIEF DESCRIPTION OF THE DRAWINGS

FIG. 1 shows a perspective view of a representative bearing cage according to the present teachings.

FIG. 2 shows a segment of the bearing cage of FIG. 1 in greater detail.

### DETAILED DESCRIPTION OF THE INVENTION

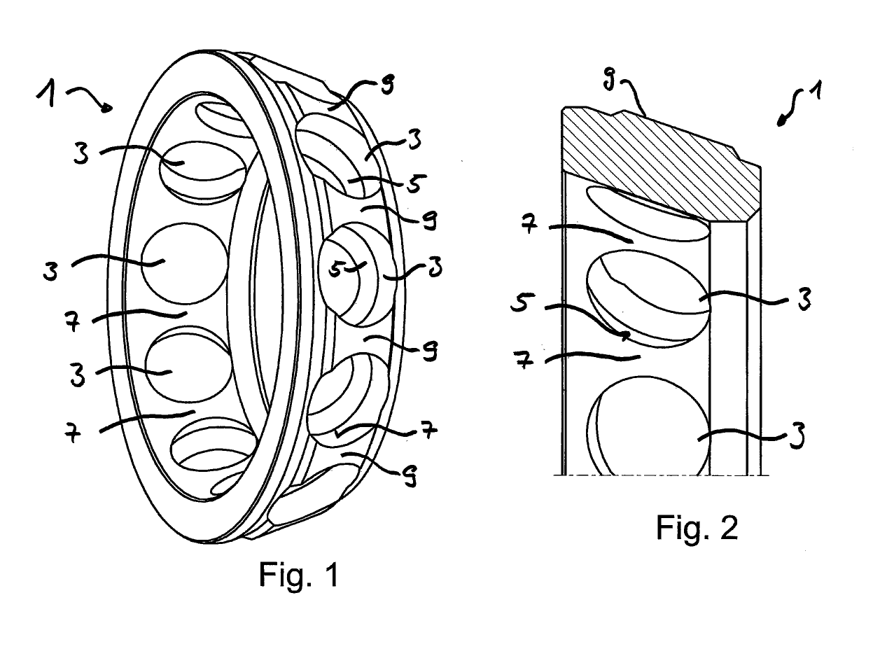

In FIGS. 1 and 2, an exemplary embodiment of the invention is illustrated in different views. FIG. 1 shows a cage 1 for an angular contact ball bearing. In accordance with the design for an angular contact ball bearing, the cage 1 has an inner diameter that enlarges along the axial direction. FIG. 2 shows only a segment of a cross-sectional illustration of the cage 1, whereas FIG. 1 shows a perspective illustration.

The cage 1 includes pockets 3 for retaining balls of the angular contact ball bearing. Adjacent pockets 3 are each separated by a bridge (spacer) 7. The illustration of FIG. 2 has been selected such that the sectional view extends through one of the bridges 7 in the middle between two of the pockets 3 of the cage 1.

In order to prevent the balls from falling out of the cage 1 when assembling or inserting into a corresponding outer ring of an angular contact ball bearing, the pockets 3 preferably have inwardly-tapered shoulders 5. In this case, the diameter of the pockets 3 narrows towards the radially-inner side of the pockets 3 so that the balls can not fall through the pockets 3 in the radially-inward direction.

During operation of the angular contact ball bearing, edge stresses develop, in particular, at, along or around the edges of the pockets 3 due to the contact with the balls. The edge stresses are the largest in the area of the bridges 7, since most of the load is applied there.

To minimize the edge stresses, the cage 1 includes outward shapes or bulges 9 at or along at least the portion of the edge of the pockets 3 adjacent to each bridge 7. The outward shapes 9 are disposed at or along the edge of the pockets 3 such that they lie in the zones of the largest edge stresses. The edge of the pockets 3 is reinforced due to the configuration of the outward shapes 9, such that the edge stresses are reduced. As a consequence, there is a reduction of the loading of the material of the cage 1 in the areas having the highest danger of cracking and/or breaking The service life of such a cage 1 is thus increased as compared to known embodiments.

In the alternative, the outward shapes 9 can also be formed so as to be radially-encircling and connected. In this case, an especially strong reinforcement of the cage can be achieved.

In a further alternative design, corresponding outward shapes (bulges) are also disposed on the radially-inward-lying sides of the cage 1. This is especially expedient when not only the radially-outward lying edges of the cage pockets are subjected to especially high loadings from the roller bodies, but also the radially-inward-lying edges.

As indicated in FIG. 1, the outward shapes or bulges 9 may have an hourglass shape, in particular in embodiments in which the pockets 3 are circular shaped. In addition or in the alternative, the outward shapes or bulges 9 may lie entirely within the axial length of the pockets 3. In addition or in the alternative, the outward shapes or bulges 9 may have a uniform radial thickness along the axial direction of the cage 1.

The advantages of the present teachings can be utilized for cages made of a variety of materials, e.g., polymer, brass or steel. Furthermore, the present teachings are not limited to cages for angular contact ball bearings. Even in other types or geometries of roller bearings, damage can be prevented by the reinforcement- or load-relieving means to reduce contact stresses that occur in the cage when contacting the roller bodies. Thus, cages according to the present teachings may also be advantageously utilized in cylindrical roller bearings, tapered roller bearings, ball bearings, etc.

A representative, non-limiting example of the present invention was described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing cages and methods for manufacturing the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Cage

3 Pocket

5 Shoulder

7 Bridge (spacer)

9 Outward shape (bulge)

1. A roller bearing cage comprising:
a plurality of pockets configured to respectively retain roller bodies,
at least one outward bulge disposed along at least a portion of an edge of at least one of the pockets, the at least one outward shape extending from the cage at least one of radially inwardly and radially outwardly and being formed such that, during operation of the roller bearing, the at least one outward bulge reduces edge stresses in the cage that develop due to contact of the roller bodies with the cage.

2. A roller bearing cage according to claim 1, wherein at least one outward bulge is provided at each of the pockets.

3. A roller bearing cage according to claim 2, wherein a plurality of outward bulges are disposed at at least one of: a radially-inward-lying opening of the pockets and a radially-outward-lying opening of the pockets.

4. A roller bearing cage according to claim 3, wherein the outward bulges are disposed along a portion of the edge of each pocket that is configured to be adjacent to a roller body.

5. A roller bearing cage according to claim 4, wherein the outward bulges conform to the shape of each bridge extending between two pockets.

6. A roller bearing cage according to claim 5, wherein the outward bulges are disposed between each of the pockets.

7. A roller bearing cage according to claim 1, wherein a plurality of outward bulges are disposed at at least one of: a radially-inward-lying opening of the pockets and a radially-outward-lying opening of the pockets.

8. A roller bearing cage according to claim 1, wherein the at least one outward bulge is disposed along a portion of the edge of a pocket that is configured to be adjacent to a roller body.

9. A roller bearing cage according to claim 8, wherein the at least one outward bulge conforms to the shape of a bridge extending between two pockets.

10. A roller bearing cage according to claim 9, wherein an outward bulge is disposed between each two adjacent pockets.

11. An angular contact ball bearing comprising:
an inner bearing ring,
an outer bearing ring, and
the cage according to claim 6 disposed between the inner and outer bearing rings, wherein a ball is retained in each of the respective pockets and an inner diameter of the cage enlarges in an axial direction of the cage.

12. An angular contact ball bearing comprising:
an inner bearing ring,
an outer bearing ring, and
the cage according to claim 1 disposed between the inner and outer bearing rings, wherein a ball is retained in each of the respective pockets and an inner diameter of the cage enlarges in an axial direction of the cage.

13. A roller bearing cage, comprising:
a first ring,
a second ring spaced from the first ring in an axial direction,
a plurality of spacers axially extending between the first and second rings, the spacers defining a plurality of pockets that are configured to retain respective roller bodies,
wherein a radially-extending bulge is formed on each spacer at least along edges of the pockets configured to be adjacent to the roller bodies retained therein, the radially-extending bulges being configured to reduce edge stresses in the cage caused by the roller bodies contacting the spacers during operation.

14. A roller bearing cage according to claim 13, wherein the radially-extending bulges extend radially outwardly from the spacers.

15. A roller bearing cage according to claim 14, wherein the radially-outward extending bulges have a length in the axial direction that falls entirely within a length of the pockets in the axial direction.

16. A roller bearing cage according to claim 15, wherein the pockets are circular shaped and the radially-outward extending bulges have an hourglass shape.

17. A roller bearing cage according to claim 16, wherein the radially-outward extending bulges have a uniform radial thickness along the axial direction.

18. A roller bearing cage according to claim 17, wherein the first ring has a smaller diameter than the second ring.

19. A roller bearing cage according to claim 18, wherein radially-inward shoulders of the pockets are inwardly tapered.

20. An angular contact ball bearing comprising:
an inner bearing ring,
an outer bearing ring, and
the cage according to claim 19 disposed between the inner and outer bearing rings, wherein a ball is retained in each of the respective pockets.
